(19) United States
(12) Patent Application Publication
(10) Pub. No.: US 2014/0022623 A1
(43) Pub. Date: Jan. 23, 2014

(54) WATER PROOF DISPLAY DEVICE CONSISTING OF EPD AND LED MATRIX

(71) Applicant: Chih-Chien Yen, New Taipei City (TW)

(72) Inventor: Chih-Chien Yen, New Taipei City (TW)

(21) Appl. No.: 13/551,356

(22) Filed: Jul. 17, 2012

(51) Int. Cl. G02F 1/167

(52) U.S. Cl. 359/296

(57) ABSTRACT

A display module includes a circuit board, a plurality of electrophortetic display pixels and a transparent coating. The circuit board has a plurality of light-emitting diodes disposed thereon. A plurality of electrophortetic display pixels are arranged over the circuit board, and each electrophortetic display pixel has a through hole via which each corresponding light-emitting diode goes through and protrudes out. The transparent coating is arranged over the electrophortetic display pixels and the transparent coating at least seals the through hole of each electrophortetic display pixel.

### BACKGROUND

1. Field of Invention

The present invention relates to an electronic display device, and especially to the display device consisting of the EPD (Electrophortetic Display Element) and LED (Light-Emitting Diode) matrix.

2. Description of Related Art

The electrophoretic display elements, called E-paper traditionally, are becoming more mature in the field of electronic display equipment. The characteristics of E-paper display technology includes low power consumption rate, thin thickness of 0.1 mm, display of self-maintained contents, non-self-luminescence, etc., wherein the characteristic of low power consumption rate applying onto information display equipment may be a great advantage, and such equipment being operated based on a battery without other power sources shall save a great cost. Thus, the traditional LED display may be a disadvantage. In addition, the equipment for EPD with the features of lightweight and small size may be installed anywhere very easily, and this is superior to the prior arts.

On the contrary, the main weakness of the equipment constructed by EPD is non-self-luminescence. Therefore, at least one light source may be a necessity in a dark place or at night, and the characteristic of low power consumption rate shall be lost. In the present situation, the sites for applying EPD are then restricted.

The inventor of the present invention has developed the technology related to the electronic display equipment for a long time and thus produced the device of the present invention. It is to combine the display equipment with EPD and LED, and hence the device is able to display information by means of EPD in the daytime and LED light at night. The total amount of LED and related components of the device is 1/10 of the LED display traditionally used. Therefore, the difference between the two devices is huge, because LEDs of the device of the present invention may be installed in the places where LEDs should be at night. Compared with the EPD lighted by external light source, the present device is capable of saving 50-80% energy.

LEDs only light up the area where EPD display, and other areas without the LED need to have contrast luminance comparing with the LED light for promoting the light effect. As aforesaid, the high efficiency electronic display device only needs 1/10 of the amount of LEDs and related components of traditional LED display, and further, the device weight of the present invention is totally different.

### SUMMARY

It is therefore an objective of the present invention to provide a waterproof display device consisting of the EPD (Electrophortetic Display Element) and LED (Light-Emitting Diode) matrix.

In accordance with the foregoing and other objectives of the present invention, a display module includes a circuit board, a plurality of electrophortetic display pixels and a transparent coating. The circuit board has a plurality of light-emitting diodes disposed thereon. A plurality of electrophortetic display pixels are arranged over the circuit board, and each electrophortetic display pixel has a through hole via which each corresponding light-emitting diode goes through and protrudes out. The transparent coating is arranged over the electrophortetic display pixels and the transparent coating at least seals the through hole of each electrophortetic display pixel.

According to another embodiment disclosed herein, the transparent coating is arranged over a top portion of each light-emitting diode which protrudes out of each corresponding through hole.

According to another embodiment disclosed herein, the transparent coating is a macromolecule coating.

According to another embodiment disclosed herein, the transparent coating is further arranged over a bottom surface of the circuit board.

According to another embodiment disclosed herein, the transparent coating is an epoxy resin, a silicone resin, a polyvinylchloride coating or a varnish coating.

According to another embodiment disclosed herein, each electrophortetic display pixel includes an upper transparent electrode, a lower electrode and an E-ink capsule layer located between the upper transparent electrode and the lower electrode.

Thus, the present invention provides a waterproof display device consisting of the EPD (Electrophortetic Display Element) and LED (Light-Emitting Diode) matrix has a transparent coating to at least watertight or airtight seal the through hole of each electrophortetic display pixel so as to prolong the usage life of the display module. Furthermore, the transparent coating hardly affects the display performance of the electrophortetic display unit and the LED unit and adds little to the thickness and weight of the display module.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a cross-sectional view of a display module according to one preferred embodiment of this invention;

FIG. 2 illustrates a top view of the display module in FIG. 1;

FIG. 3 illustrates a cross-sectional view of a display module according to another preferred embodiment of this invention; and

FIG. 4 illustrates a cross-sectional view of a display module according to still another preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

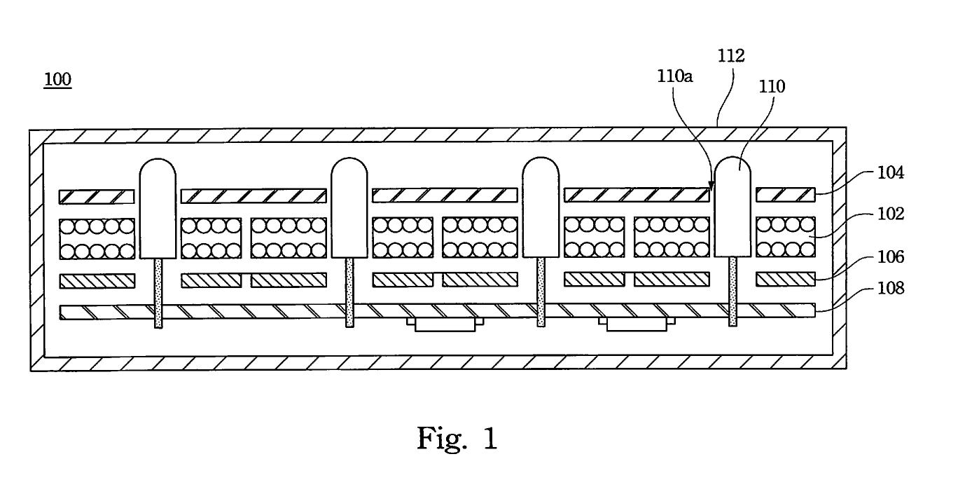

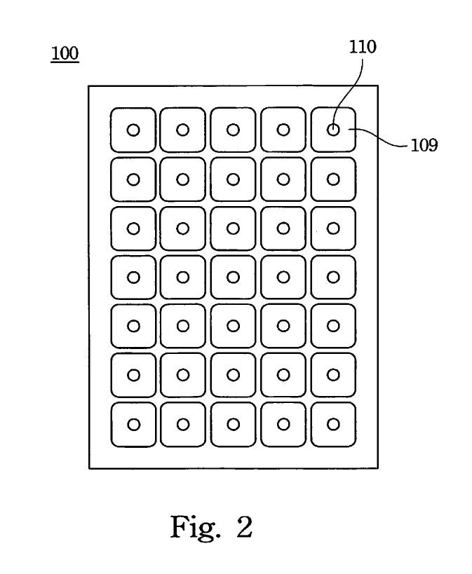

FIG. 1 illustrates a cross-sectional view of a display module according to one preferred embodiment of this invention, and FIG. 2 illustrates a top view of the display module in FIG. 1. A display module 100 basically includes an electrophortetic display unit, an LED unit and an outer housing 112. The LED unit includes a circuit board 108 and a plurality of light-emitting diodes 110 mounted on the circuit board 108. A plurality of electrophortetic display pixels 109 are arranged over the circuit board 108, and each electrophortetic display pixel 109 has a through hole 110a via which each corresponding light-emitting diode 110 goes through and protrudes out. The display module 100 only employs the electrophortetic display pixels 109 to display information during the day, and employs the light-emitting diodes 110 to illuminate the electrophortetic display pixels 109 during the night. In this embodiment, because each electrophortetic display pixel 109 is paired with a corresponding light-emitting diode 110, each electrophortetic display pixel 109 has a through hole 110a allowing each corresponding light-emitting diode 110 to go through and protrude out. Each electrophortetic display pixel 109 includes an upper transparent electrode 104, a lower electrode 106 and an E-ink capsule layer 102. The E-ink capsule layer 102 is located between the upper transparent electrode 104 and the lower electrode 106. Because the through hole 110a penetrates all the upper transparent electrode 104, the lower electrode 106 and the E-ink capsule layer 102 and the display module 100 is used mainly in outdoor displaying, the E-ink capsule layer 102 would be easily damaged when the through hole 110a is not watertight or airtight sealed.

In order to prolong the usage life of the E-ink capsule layer 102, the transparent outer housing 112 is used to watertight or airtight seal all the electrophortetic display pixels 109 and the light-emitting diodes 110. However, when the transparent outer housing 112 is used to seal all the electrophortetic display pixels 109 and the light-emitting diodes 110, the display module is much more thick and heavier than all the electrophortetic display pixels 109 and the light-emitting diodes 110 without the outer housing 112, thereby sacrificing the light and thin advantage of the electrophortetic display unit. The following solution is provided for the foregoing drawbacks of using the outer housing 112 to seal all the electrophortetic display pixels 109 and the light-emitting diodes 110.

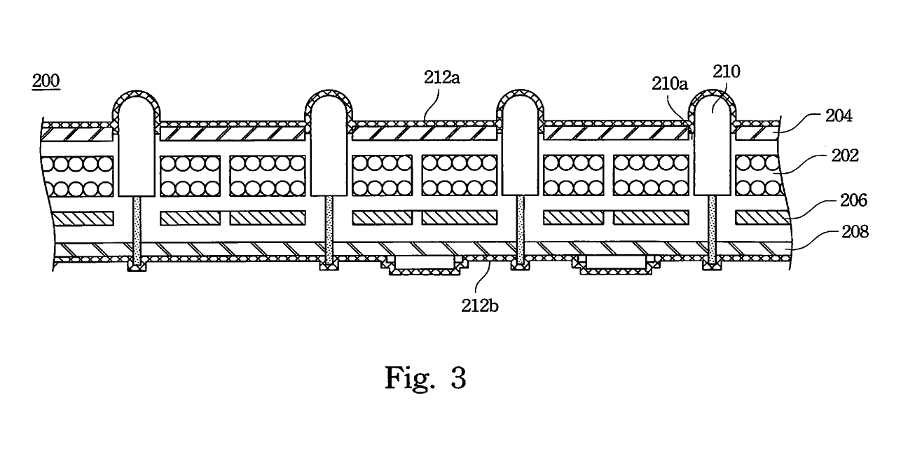

FIG. 3 illustrates a cross-sectional view of a display module according to another preferred embodiment of this invention. A display module 200 basically includes an electrophortetic display unit, an LED unit and a transparent coating. The transparent coating serves the same function as the outer housing 112 does, but does not result in an overly thick and heavy display module. The LED unit includes a circuit board 208 and a plurality of light-emitting diodes 210 mounted on the circuit board 208. A plurality of electrophortetic display pixels are arranged over the circuit board 208, and each electrophortetic display pixel has a through hole 210a via which each corresponding light-emitting diode 210 goes through and protrudes out. Each electrophortetic display pixel includes an upper transparent electrode 204, a lower electrode 206 and an E-ink capsule layer 202. The E-ink capsule layer 202 is located between the upper transparent electrode 204 and the lower electrode 206. Because the through hole 210a penetrates all the upper transparent electrode 204, the lower electrode 206 and the E-ink capsule layer 202, the E-ink capsule layer 202 would be easily damaged when the through hole 210a is not watertight or airtight sealed. The transparent coating 212a is used to at least watertight or airtight seal the through hole 210a of each electrophortetic display pixel. In this embodiment, the transparent coating 212a is deposited on an upper surface of the upper transparent electrode 204, filled into the through hole 210a and deposited over a top portion of each light-emitting diode 210 which protrudes out of each corresponding through hole 210a by means of a vacuum vapor deposition, and the transparent coating 212b is deposited over a bottom surface of the circuit board 208 by the same way so as to seal the whole display module 200. The transparent coating (212a, 212b) can be formed to be a very thin layer by means of the vacuum vapor deposition such that it hardly affects the display performance of the electrophortetic display unit and the LED unit and adds almost nothing to the thickness and weight of the display module 200. In this embodiment, the transparent coating can be formed from a macromolecule material or other materials suitably used in the vacuum vapor deposition.

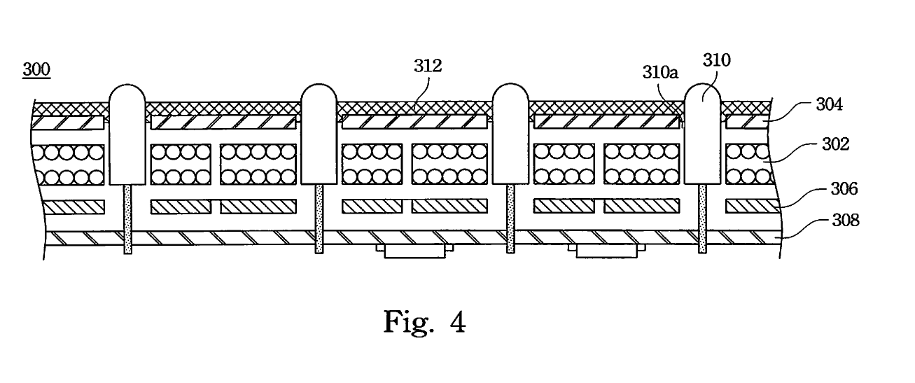

FIG. 4 illustrates a cross-sectional view of a display module according to still another preferred embodiment of this invention. A display module 300 basically includes an electrophortetic display unit, an LED unit and a transparent coating. The transparent coating 312 serves the same function as the transparent coating 212a does, but they are coated over the display module by different ways. The LED unit includes a circuit board 308 and a plurality of light-emitting diodes 310 mounted on the circuit to board 308. A plurality of electrophortetic display pixels are arranged over the circuit board 308, and each electrophortetic display pixel has a through hole 310a via which each corresponding light-emitting diode 310 goes through and protrudes out. Each electrophortetic display pixel includes an upper transparent electrode 304, a lower electrode 306 and an E-ink capsule layer 302. The E-ink capsule layer 302 is located between the upper transparent electrode 304 and the lower electrode 306. Because the through hole 310a penetrates all the upper transparent electrode 304, the lower electrode 306 and the E-ink capsule layer 302, the E-ink capsule layer 302 would be easily damaged when the through hole 310a is not watertight or airtight sealed. The transparent coating 312 is used to at least watertight or airtight seal the through hole 310a of each electrophortetic display pixel. In this embodiment, the transparent coating 312 is directly coated on an upper surface of the upper transparent electrode 304 and filled into the through hole 310a so as to seal the upper surface of the display module. The transparent coating may be coated over a top portion of each light-emitting diode which protrudes out of each corresponding through hole (not illustrated in the drawings) or coated over a bottom surface of the circuit board (not illustrated in the drawings). The transparent coating 312 is not formed by means of the vacuum vapor deposition such that it is thicker than the transparent coating 212a, but still not affects the display performance of the electrophortetic display unit and the LED unit and adds little to the thickness and weight of the display module 300. In this embodiment, the transparent coating 312 can be epoxy resins, silicon resins, polyvinylchloride coatings, varnish coating or other suitable materials.

According to the above-discussed embodiments, the present invention provides a waterproof display device consisting of the EPD (Electrophortetic Display Element) and LED (Light-Emitting Diode) matrix has a transparent coating to at least watertight or airtight seal the through hole of each electrophortetic display pixel so as to prolong the usage life of the display module. Furthermore, the transparent coating hardly affects the display performance of the electrophortetic display unit and the LED unit, and adds little to the thickness and weight of the display module.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display module comprising:
a circuit board having a plurality of light-emitting diodes disposed thereon;
a plurality of electrophortetic display pixels disposed over the circuit board, and each electrophortetic display pixel having a through hole via which each corresponding light-emitting diode goes through and protrudes out; and
a transparent coating disposed over the electrophortetic display pixels and the transparent coating at least sealing the through hole of each electrophortetic display pixel.

2. The display module of claim 1, wherein the transparent coating is disposed over a top portion of each light-emitting diode which protrudes out of each corresponding through hole.

3. The display module of claim 2, wherein the transparent coating is a macromolecule coating.

4. The display module of claim 3, wherein the transparent coating is further disposed over a bottom surface of the circuit board.

5. The display module of claim 2, wherein the transparent coating comprises epoxy resin, silicone resin, a polyvinylchloride coating or a varnish coating.

6. The display module of claim 1, wherein the transparent coating is a macromolecule coating.

7. The display module of claim 1, wherein the transparent coating comprises epoxy resin, silicone resin, a polyvinylchloride coating or a varnish coating.

8. The display module of claim 1, wherein the transparent coating is further disposed over a bottom surface of the circuit board.

9. The display module of claim 1, wherein each electrophortetic display pixel comprises:
an upper transparent electrode and a lower electrode; and
an E-ink capsule layer disposed between the upper transparent electrode and the lower electrode.
